(19) United States
(12) Patent Application Publication
(10) Pub. No.: US 2010/0011839 A1
(43) Pub. Date: Jan. 21, 2010

(54) Mattress Cover Leak Detection Apparatus

(76) Inventor: Robert K. Browning, Nashville, TN (US)

Correspondence Address: PITTS AND BRITTIAN P C, P O BOX 51295, KNOXVILLE, TN, 37950-1295, US

(21) Appl. No.: 12/175,523

(22) Filed: Jul. 18, 2008

(51) Int. Cl. G01M 3/04; G01N 29/02

(52) U.S. Cl. 73/40; 73/592

(57) ABSTRACT

A system for detecting leaks in mattresses. The system allows for the detection of small holes in a mattress by applying pressurized gas or fluid to the mattress and observing the escape of gas or fluid through tears and incisions in the mattress cover in the formation of bubbles in a layer of solution covering the mattress cover. In an alternate embodiment, the escape of gas or fluid through the small holes produces ultrasonic vibrations, which an ultrasonic listening device detects, allowing an operator to determine the location of the holes.

### CROSS-REFERENCE TO RELATED APPLICATIONS

Not Applicable

### STATEMENT REGARDING FEDERALLY-SPONSORED RESEARCH OR DEVELOPMENT

Not Applicable

### BACKGROUND OF THE INVENTION

1. Field of Invention

The present invention relates generally to system for detecting leaks in mattress covers. More particularly, the invention is directed toward a device that allows for the detection of holes in a mattress cover using forced air.

2. Description of the Related Art

The prevention of hospital-acquired infections has become a focal point of several regulatory and monitoring groups associated with the health care industry and has been a longstanding goal of hospitals in general. A potential source for the transmission of biological contaminants between patients is contaminated filler material found inside mattresses used on beds, procedure tables, stretchers and furniture. Although the surfaces of these items are regularly and systematically cleaned, any breach in the ticking or cover material can allow body fluids to penetrate the surface and contaminate the filling.

Many covered cushions are equipped with zippers and other closures that permit the inspection of the inner material (including sometimes the removal of the filling for close inspection). However, in the case of advanced hospital bed mattresses, the inspection is complicated by the existence of many components (e.g., air bladders and differing foam densities). A thorough inspection of these sophisticated mattresses can require significant effort and time.

Other devices and methods have been developed to address these and other problems. Typical of the art is the device disclosed in U.S. Pat. No. 3,388,587, issued on Jun. 18, 1968 to Hara et al. The '587 patent discloses a leakage inspection method which comprises applying gas pressure to a structure and thereafter checking for leaking defective parts, the area to be checked for leakage being covered with an adherent film containing an adhesion agent mixed with a foaming agent in a solvent so that a long-sustaining solid spongy foam mass is formed in said film at leakage points.

### BRIEF SUMMARY OF THE INVENTION

A mattress cover leak detection system is disclosed. This system uses a device that includes a blower, a conduit for conveying gas from the blower to the mattress, and an interface for attaching the conduit to the mattress cover. In some embodiments, the device also includes a pressure regulator for preventing the excessive build-up of gas pressure within the interior of the mattress cover. The device works in conjunction with a leak indicator. In a preferred embodiment, the leak indicator includes a solution that has been spread over a portion of the external surface area of said mattress. As the blower, through the conduit and the interface, transfers air into the interior of the mattress cover, the air pressure within the mattress cover increases, and some of the air seeks to escape through any breach that has been formed in the mattress cover. The air escaping through said breach, upon interacting with the film, forms one or more bubbles, which indicate the position of the breach. In another embodiment, the air escaping through the breach produces ultrasonic vibrations, which an ultrasonic listening device detects, allowing an operator to determine the location of the breach.

In at least one embodiment of the invention, the interface for attaching the conduit to the mattress cover includes a detachable nozzle adapter that uses a pair of flanges to create a seal within an opening in the mattress cover and that also couples with said conduit. Alternatively, the interface for attaching the conduit to the mattress cover may include an adapter incorporated into the mattress cover and designed to couple with the conduit.

In the illustrated embodiments, the pressure regulation mechanism includes a pressure sensor, a hydraulic or electronic shut-off switch connected with the blower, and a pressure regulator. When said pressure sensor detects that the pressure of the gas within the mattress cover has reached a predetermined maximum limit, said pressure sensor activates said shut-off switch. The shut-off switch can divert the flow of gas from the blower entering the conduit, or reduce the rate at which the blower supplies gas to the conduit, or cause the blower to cease blowing gas into the conduit. Likewise, if the pressure sensor detects that the pressure of the gas within the mattress cover has dropped below a pre-determined minimum, then the pressure sensor activates the pressure regulator to increase the pressure of the gas coming from the blower.

### BRIEF DESCRIPTION OF THE DRAWINGS

The above-mentioned features of the invention will become more clearly understood from the following detailed description of the invention read together with the drawings in which:

FIG. 1 is a perspective view of one embodiment of the device;

FIG. 2 is an exploded view of the embodiment displayed in FIG. 1;

FIG. 3 is a cross-sectional view of the interior of a mattress cover with a breach;

FIG. 4 is a perspective view of an embodiment of the adapter used to interface the conduit and the mattress cover;

FIG. 5 is a close-up view of the adapter displayed in FIG. 4 in use with a mattress cover;

FIG. 6 is a cross-sectional view of the adapter displayed in FIG. 4 in use with a mattress cover and a conduit;

FIG. 7 is a cross-sectional view of the interior of a mattress cover with a breach showing the formation of a bubble at the position of the breach;

FIG. 8 is a perspective view of an embodiment of the system using the detection of ultrasonic waves to determine the location of a breach; and

FIG. 9 is a block diagram of one embodiment of the invention with a pressure regulation mechanism.

### DETAILED DESCRIPTION OF THE INVENTION

The present invention provides a system that allows for the detection of small tears and incisions in a mattress cover. By applying gas pressure or a pressurized fluid to the interior of the mattress cover, one may observe the escape of gas or fluid through tears and incisions in the mattress cover from the formation of bubbles in a layer of solution applied to the mattress cover. In another embodiment, the air escaping through the breach produces ultrasonic vibrations, which an ultrasonic listening device detects, allowing an operator to determine the location of the breach. The system generally includes a blower, a conduit for conveying gas from the blower to the mattress, an interface for attaching the conduit to the mattress cover, and a pressure regulator for preventing the excessive build-up of gas pressure within the interior of the mattress cover.

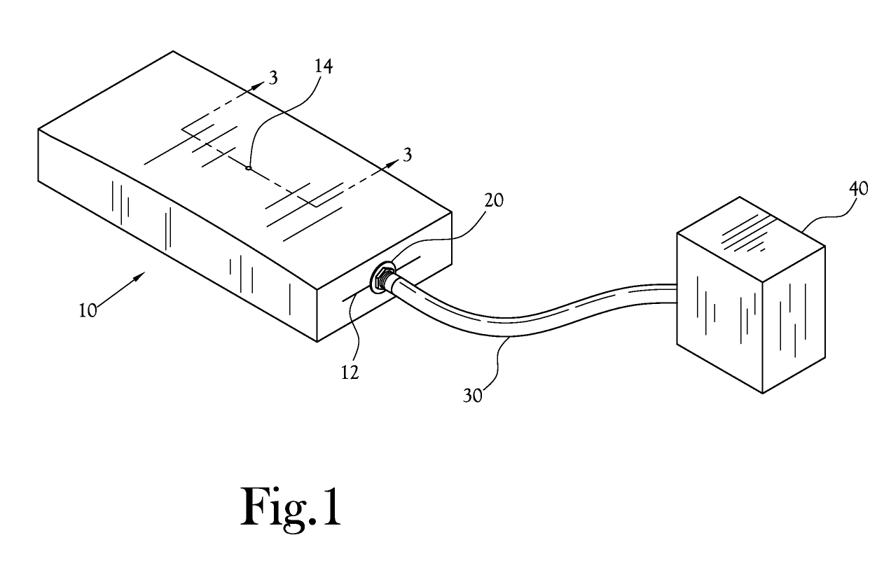

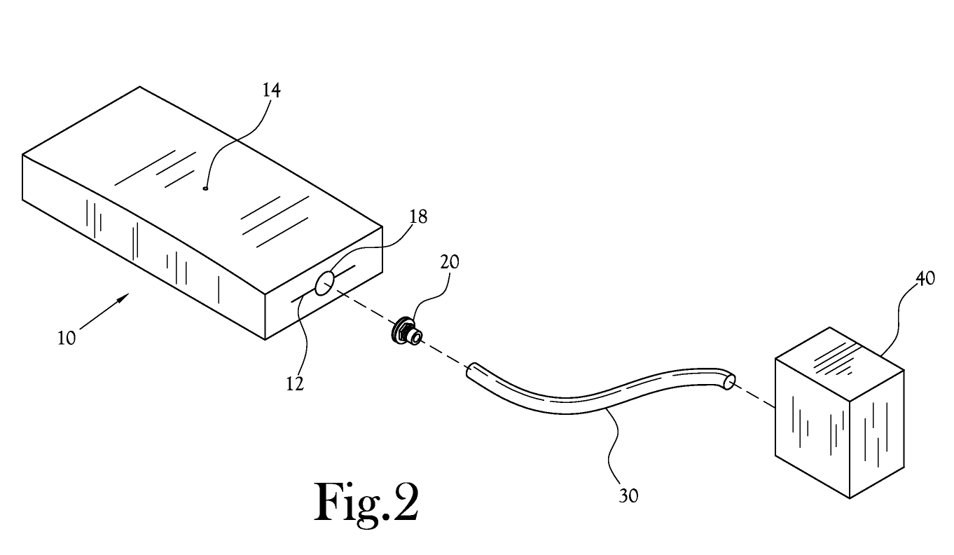

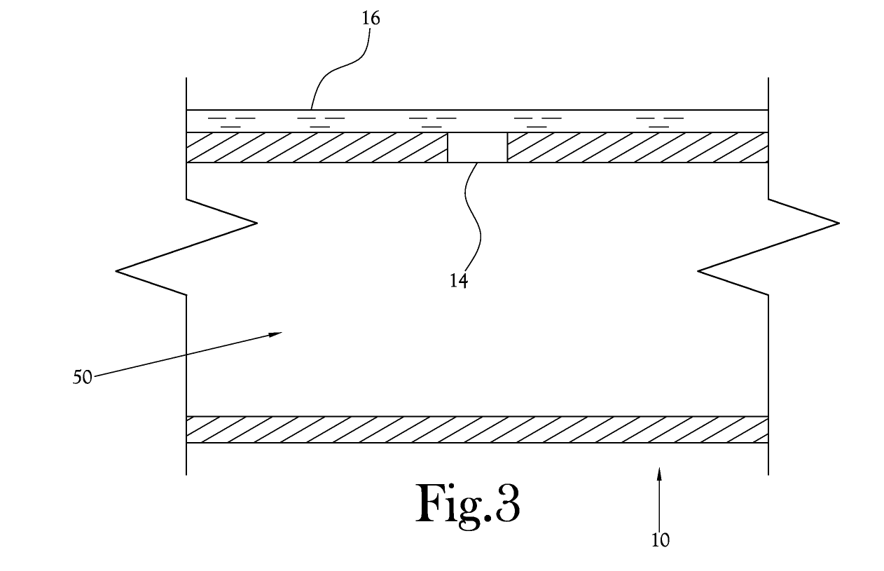

One embodiment of the invention is displayed in FIG. 1. A mattress cover 10 is displayed, together with an interface 20, a conduit 30, and a blower 40. The mattress cover 10 includes a closeable opening 12 along at least one side. As shown in FIG. 1, the mattress cover 10 contains a representative hole 14. (One skilled in the art will recognize that the hole 14 is representative, that an actual mattress cover might contain no holes or multiple holes, and that any such hole in a mattress cover could be in a different position on the mattress cover. Further, any such hole might not be visible to the unaided eye.) Referring to FIG. 3, a solution 16 is applied to one or more surfaces of the mattress cover 10 where a leak 14 might be present. Referring to the exploded view of the system in FIG. 2, a small opening 18 in the mattress cover 10 is formed by partially unzipping the zipper 12. An interface 20 is then inserted into the opening 18. The interface 20 is of a design to form a seal between the mattress cover 10 and a conduit 30 that is connected to a blower 40.

The solution 16 used to cover the mattress cover in a thin film normally includes water or some similar liquid as a solvent and an amphiphilic organic surfactant that will promote the formation of bubbles. Those skilled in the art will recognize that many such solutions are possible. The solution may also include an adhesive agent that helps to ensure that the film remains positioned on the surface of the mattress cover. In some embodiments, the solution also includes disinfecting agents, such as antimicrobial chemicals and germicides. In such embodiments, the application of the solution to the mattress cover allows an operator to combine routine exterior surface disinfection with the detection of leaks.

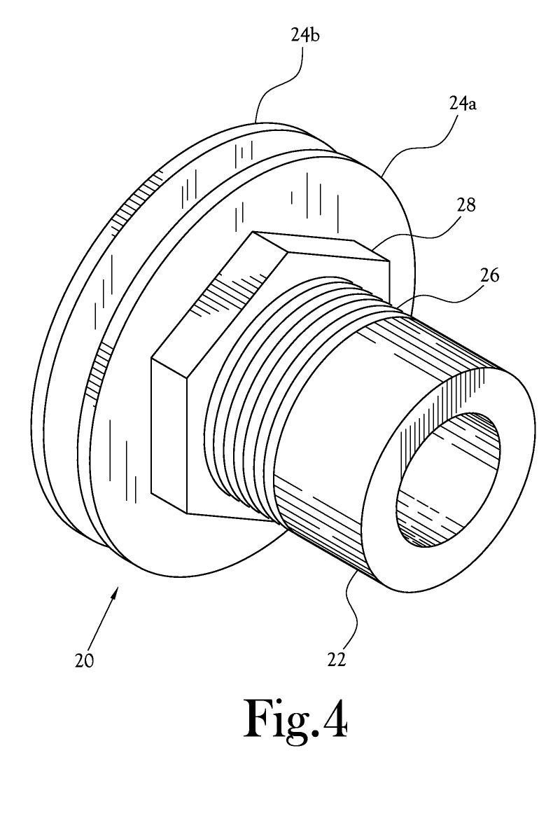

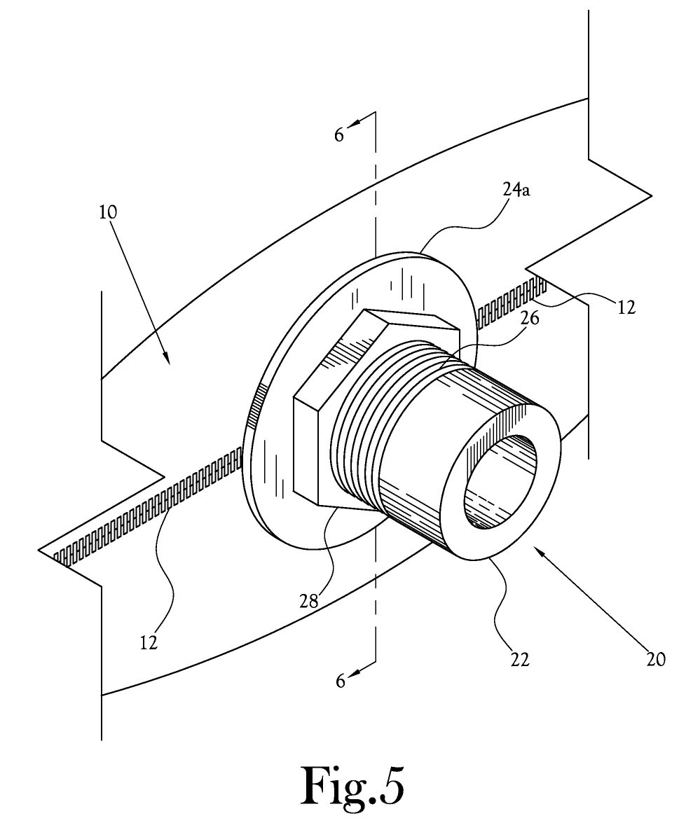

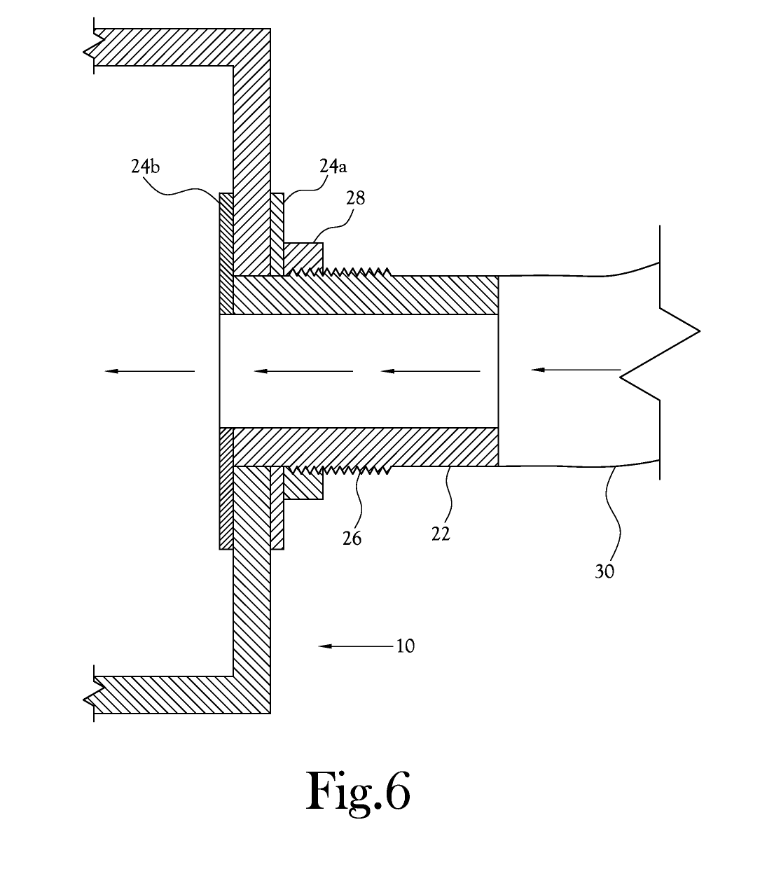

FIG. 4 displays one embodiment of the interface 20. This interface or adapter 20 includes a nozzle 22 and a pair of flanges 24a and 24b. As shown in FIG. 5 and FIG. 6, the adapter 20 is inserted into the opening 18 in the zipper 12 of the mattress cover 10. The flanges 24a and 24b overlap with the material of the mattress cover 10, one flange 24a being on the exterior of the mattress cover and the other 24b being on the interior. Together with the nozzle 22, the flanges 24a and 24b form a seal with the mattress cover 10 to inhibit the escape of air from the interior of the mattress cover 10 through the opening 18. A portion of the exterior of the nozzle 22 includes threads 26 suitable for interacting with a nut 28 or a similar fastening device. When positioned along the threads 26 near the mattress cover 10, the nut 28 helps to ensure that the flange 24a is firmly pressed against the mattress cover 10, thereby assisting in the formation of a seal to inhibit the escape of air. The other flange 24b is typically connected immovably to the nozzle 22.

The various components of the adapter 20 typically are made of plastic, metal, or some similar material suitable for forming a tight seal with the fabric of the mattress cover 10. Those skilled in the art will recognize that the adapter 20 described above is one possible embodiment of the interface between the mattress cover 10 and the conduit 30 and that other embodiments of the adapter are possible. Those skilled in the art will also recognize that there exist other means for fastening the seal-creating components of the interface. Further, in some alternative embodiments of the invention, the interface may be a permanent piece incorporated into the mattress cover.

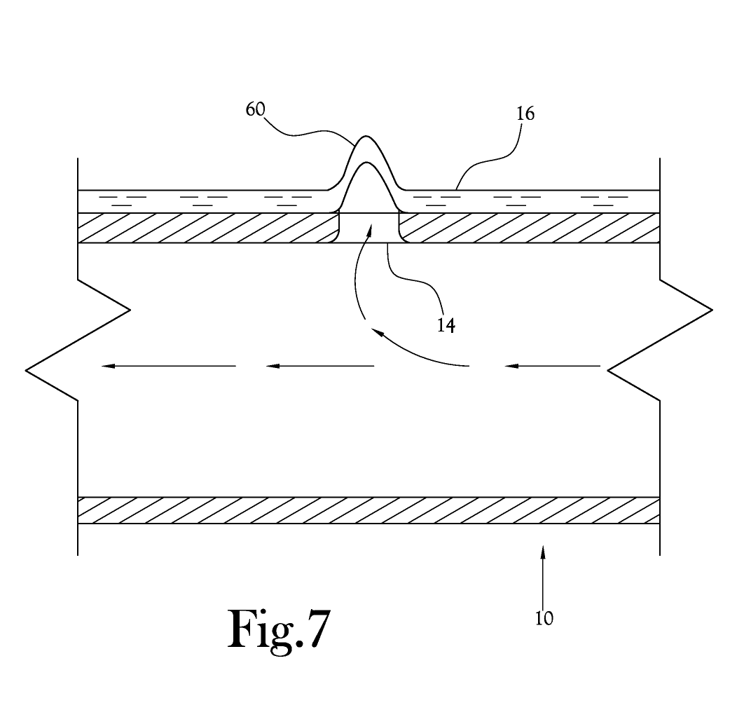

The nozzle 22 couples with the conduit 30 in such a way as to allow air to pass from the interior of the conduit 30 into the interior of the nozzle 22 and thence into the interior of the mattress cover 10, as shown in FIG. 6. The other end of the conduit 30 is connected with the blower 40 in such a way so that the blower 40 propels air or gas into the conduit 30. Referring again to FIG. 1 and initially to FIG. 6, the blower 40 blows air or a gas through the conduit 30 and the adapter 20 into the interior of the mattress cover 10. As the gas pressure within the mattress cover 10 increases, some of the air will escape through the hole 14. Referring to FIG. 7, when the air passes through the hole 14 and encounters the soapy solution 16, the air will interact with the soapy solution 16 to form a bubble 60. Observation of the bubble 60 will then reveal to an observer the location of the hole 14 in the mattress cover 10. Further, in most embodiments, as the gas pressure within the mattress cover 10 increases, the mattress cover 10 will inflate and expand, thereby opening small holes (such as those the size of the tip of a hypodermic needle) where bodily fluids have dried and sealed the holes. Thus the process of inflation of the mattress cover 10 helps to dislodge contaminants that have become caked onto the mattress cover 10 at the location of breaches in the mattress cover 10.

Those of skill in the art will recognize that the leak indicator may include substances other than the solution 16 displayed in FIG. 3 and described above. The leak indicator should be capable of covering at least a portion of the mattress cover and should include a substance which, when it interacts with the high pressure air coming from within the mattress cover, visibly indicates the interaction, as by forming bubbles or foaming. Those skilled in the art will recognize that a wide variety of substances and solutions will serve as an adequate leak indicator.

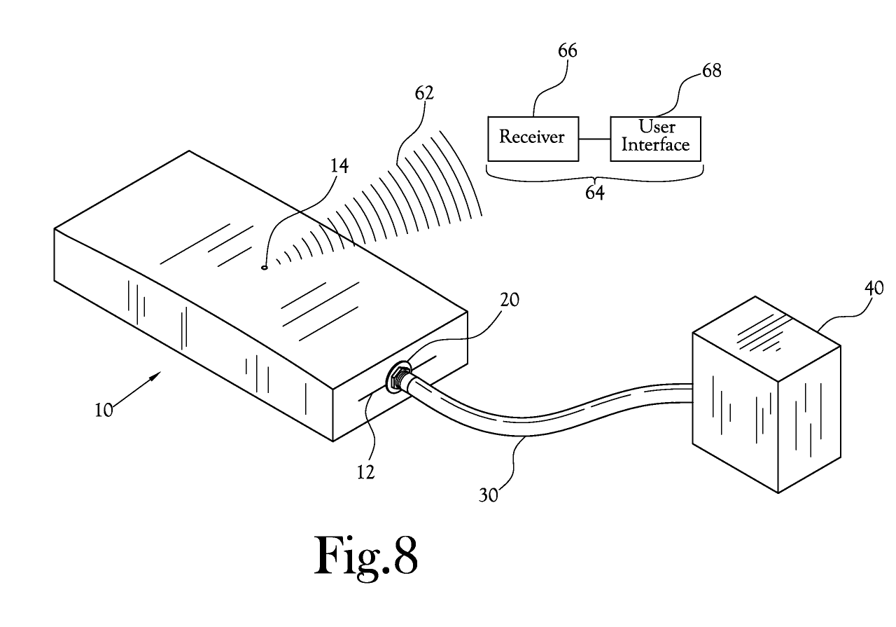

An alternative embodiment of the invention allows for the detection of a breach without the use of a solution applied to the mattress cover. In the alternative embodiment, as represented in FIG. 8, the air escaping through the breach 14 produces ultrasonic vibrations 62. An operator may then detect the location of a breach through the use of an ultrasonic listening device 64. The ultrasonic listening device 64 includes at least a receiver 66 and a user interface and display 68, the receiver being adapted to detect ultrasonic vibrations of the type emitted by air escaping the hole 14. In some embodiments, operators may use multiple ultrasonic listening devices to more readily determine the location of the breach through triangulation or similar methods.

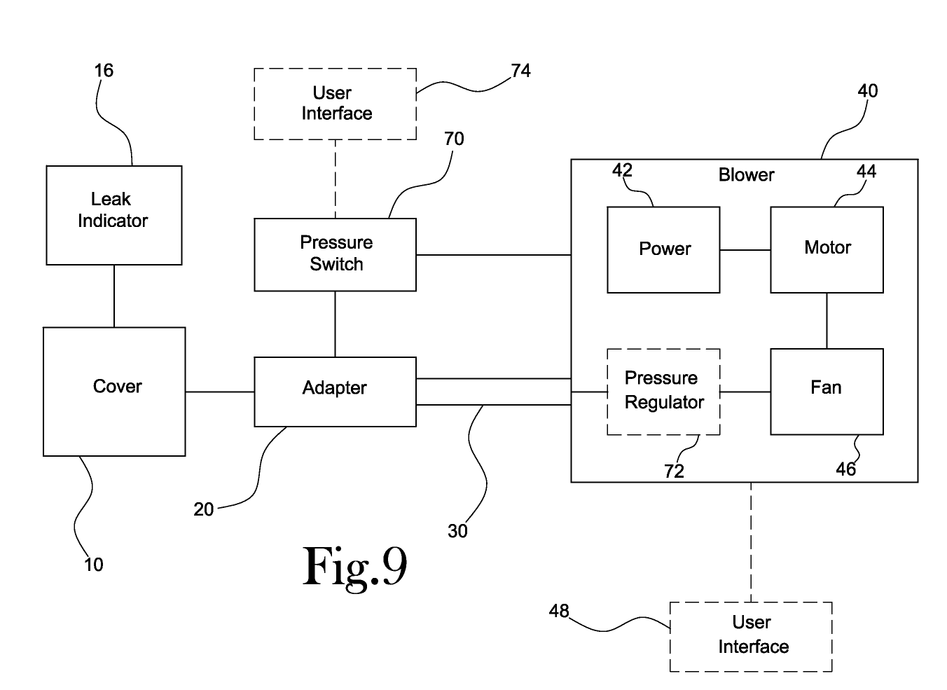

In order to prevent damage to the mattress cover or other components from the application of excessive air pressure within the mattress cover, it is useful to include a pressure regulation mechanism such as that represented in the block diagram in FIG. 9. In one embodiment, a pressure switch 70 is connected to the adapter 20 and is also in communication with the blower 40. The pressure switch 70 includes a pressure sensor, which detects when the pressure of the gas within the mattress cover 10. When the gas pressure within the mattress cover 10 increases, the gas pressure within the adapter 20 also increases. When the gas pressure within the adapter 20 reaches a predetermined maximum level, the sensor within the pressure switch 70 activates the switch, which then causes the blower 40 to decrease the pressure of the air flow entering the conduit 30. The pressure switch 70 may be either electric or hydraulic, and it may cause the blower 40 to decrease the pressure of the air flow entering the conduit 30 in a number of ways. The blower 40, as seen in FIG. 9, includes at least a power source 42, a motor 44, and a fan 46. The pressure switch 70 may interrupt the flow of power to the motor 44, or it may interact with an optional pressure regulator 72 to block some or all of the air being blown by the fan 46 into the conduit 30.

In a similar manner, in some embodiments the pressure regulation mechanism maintains a pre-set minimum air pressure within the mattress cover 10 during operation of the device. When the pressure sensor within the pressure switch 70 detects that the gas pressure within the adapter 20 has fallen below a pre-determined minimum level desirable for the effective operation of the device, the sensor within the pressure switch 70 activates the switch, which then causes the blower 40 to increase the pressure of the air flow entering the conduit 30. The pressure switch 70 may cause the blower 40 to increase the pressure of the air flow entering the conduit 30 in a number of ways. The pressure switch 70 may increase the flow of power to the motor 44, or it may interact with the optional pressure regulator 72 to allow more pressurized air being blown by the fan 46 to enter the conduit 30.

As shown in FIG. 9, the pressure switch 70 includes an optional user interface and display 74, which allows an operator to observe directly the air pressure within the adapter and to set the levels at which the pressure switch 70 activates to increase or decrease the air flow from the blower. The blower 40 also includes an optional user interface and display 48 that allows an operator directly to regulate the speed of the fan 46 and the pressure level of air entering the conduit 30.

While the present invention has been illustrated by description of some embodiments, and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants general inventive concept.

Having thus described the aforementioned invention, what is claimed is:

1. A system for detecting a breach in a mattress cover, said system comprising:
a solution adapted to forming a film on a portion of the mattress cover;
a blower for providing a pressurized fluid;
a conduit connectable to said blower for conveying the forced air from said blower to the mattress cover; and
an interface for connecting said conduit to the mattress cover;
wherein when said solution is spread over a portion of the mattress cover, the pressurized fluid conveyed into the mattress cover escapes through the breach and, interacting with said solution, forms a bubble.

2. The system of claim 1, wherein said interface is permanently incorporated into the mattress cover.

3. The system of claim 1, wherein said interface comprises a nozzle adapted to coupling with said conduit, a pair of flanges that overlap with material of the mattress cover to form a seal with the mattress cover, and means for fastening said flanges in place with respect to said nozzle and said mattress cover.

4. The system of claim 3, wherein said means for fastening comprise a series of threads on said nozzle and a nut transported along said threads to apply pressure against said flanges.

5. The system of claim 1, further comprising a pressure switch, said switch measuring pressure within said mattress cover, and said pressure switch being in communication with a pressure regulation mechanism adapted to decrease the flow of pressurized fluid from said blower to the mattress cover when the pressure within the mattress cover reaches a pre-determined maximum level and to increase the flow of pressurized fluid from said blower to the mattress cover when the pressure within the mattress cover reaches a pre-determined minimum level.

6. The system of claim 1, wherein said solution includes a disinfecting agent.

7. A system for detecting a breach in a mattress cover, said system comprising:
a blower for providing a pressurized fluid;
a conduit connectable to said blower for conveying the forced air from said blower to the mattress cover;
an interface for connecting said conduit to the mattress cover; and
an ultrasonic listening device;
wherein the pressurized fluid conveyed into the mattress cover escapes through the breach and emits ultrasonic vibrations that are detected by said ultrasonic listening device.

8. The system of claim 7, wherein said interface is permanently incorporated into the mattress cover.

9. The system of claim 7, wherein said interface comprises a nozzle adapted to coupling with said conduit, a pair of flanges that overlap with material of the mattress cover to form a seal with the mattress cover, and means for fastening said flanges in place with respect to said nozzle and said mattress cover.

10. The system of claim 9, wherein said means for fastening comprise a series of threads on said nozzle and a nut transported along said threads to apply pressure against said flanges.

11. The system of claim 7, further comprising a pressure switch, said switch measuring pressure within said mattress cover, and said pressure switch being in communication with a pressure regulation mechanism adapted to decrease the flow of pressurized fluid from said blower to the mattress cover when the pressure within the mattress cover reaches a pre-determined maximum level and to increase the flow of pressurized fluid from said blower to the mattress cover when the pressure within the mattress cover reaches a pre-determined minimum level.

12. A method for detecting a breach in a mattress cover comprising
forming a coated film over at least a portion of the external surface area of said mattress cover,
using a conduit and an interface to connect a blower to said mattress cover,
using said blower, through said conduit and said interface, to apply gas pressure into the interior of said mattress cover, and
observing the formation of one or more bubbles at the position of said breach in said mattress cover, said one or more bubbles resulting from the passage of air from said interior of said mattress cover through said breach.
